(19) United States
(12) Patent Application Publication
(10) Pub. No.: US 2006/0190552 A1
(43) Pub. Date: Aug. 24, 2006

(54) Data retention system with a plurality of access protocols

(76) Inventors: Richard H. Henze, San Carlos, CA (US); Padmanabha I. Venkitakrishnan, Sunnyvale, CA (US); Scott Marovich, East Palo Alto, CA (US); Pankaj Mehra, San Jose, CA (US); Samuel A. Fineberg, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/065,690

(22) Filed: Feb. 24, 2005

(51) Int. Cl. G06F 15/167

(52) U.S. Cl. 709/216

(57) ABSTRACT

A data retention system is described that has a plurality of access protocols. The system comprises a memory store accessible through a virtual address space, a controller communicatively coupled to the memory store, and an interface. The controller is adapted to implement a memory access protocol for accessing at least a first portion of the virtual address space and a secondary storage protocol for accessing at least a second portion of the virtual address space. The interface is communicatively coupled to the controller, and is able to be communicatively coupled to a communications link.

### BACKGROUND

A modern digital computer system often includes one or more central processing units (CPUs) which communicate with a main memory system and one or more mass storage systems. A main memory system allows fast access but is typically volatile; i.e., the memory system is susceptible to a loss of information in the event that electrical power is removed. A mass storage system is non-volatile during losses of power, but provides relatively slow access speeds (often requiring more than one millisecond), typically far slower than memory systems. Memory technologies are usually far more expensive per unit of data (e.g., kilobyte) than mass storage technologies, so much smaller data capacities of main memory are often provided. In particular, it is common to provide only a single main memory system, possibly shared among multiple CPUs, but a plurality of mass storage systems. For example, one popular combination of technologies with these characteristics is a semiconductor dynamic random access memory (DRAM) system for main memory, together with one or more mass storage systems containing rotating magnetic discs.

Historically, mechanisms and protocols developed for communicating information between a CPU and a mass storage system have usually been dissimilar in several important respects to those developed for communicating information between a CPU and a main memory system. For example, information is often communicated between a CPU and a mass storage system over a distance that may be longer, such as several meters (or, by interposing a data communication network, even many kilometers), in units of several thousand bytes, organized as “message packets,” by causing the CPU and the mass storage system to compose and decompose these packets, which may include extra information to detect and correct transmission errors, and to exchange a sequence of messages, including the desired data and extra packets to indicate whether the transfer of information occurred completely and correctly. Popular examples of the latter kind of message packet format and exchange protocol include standards such as TCP/IP, and the Small Computer System Interconnect standard (SCSI), which is particularly described in ANSI Standard X3.131-1994, and its successors and variants, such as SCSI-2, SCSI-3, and the like. Mass storage protocols are typically characterized by larger granularity and slower access times than memory access protocols.

In contrast, memory access protocols are typically characterized by fine granularity and relatively fast access time. Information is often communicated between a CPU and a main memory system over relatively short distances, such as a few inches, in units of a few binary digits at a time (these units are often called “bytes” or “words”), by causing the CPU to execute a pre-programmed “Load” or “Store” instruction for each transfer of data. Direct memory access (DMA) protocols have been developed for copying data from one region of memory to another region of memory without buffering the data in a CPU. More recently, additional memory access protocols have been developed that are useful for communicating over a network. Examples of these memory access protocols include SDP (Sockets Direct Protocol), RDMAP (Remote Direct Memory Access Protocol), and iWARP (a protocol stack comprising RDMAP, DDP (Direct Data Placement), and MPA (Marker PDU Aligned) protocols for implementing remote direct memory access over TCP/IP).

Conventional network-connected storage systems that combine some of the characteristics of disk-type devices and memory-type devices are generally designed to allow random access memory (RAM) to masquerade as a disk-type device (such as a drive, volume, logical unit, or the like). At a low level or internally, such a storage system may use memory access protocols as a transfer mechanism, to provide faster communication throughput. However, these storage systems are not designed to present themselves to external software applications as an available address range, or region, of random access memory. An external software application (such as an application running on a processor connected to such a storage system via a network) may access the durable or non-volatile storage provided by the storage system, using a mass storage protocol. Although RAM is physically present in such storage systems, the address ranges of such RAM are generally hidden, locked, or otherwise protected from external software applications, and may be inaccessible to external software applications using a memory access protocol. For example, the address ranges may be protected by a memory management system that allocates the address range to a device driver or network interface associated with the storage system. From the perspective of the external software application, such storage systems appear to be disk-type storage devices. Examples of such storage systems include hard disk drives with memory caching, RAM disks, solid-state disk systems, and conventional storage area networks.

The exclusive use of mass storage protocols for high-level or external access to such networked storage devices contributes to increased access latency times compared to memory access protocols, since mass storage protocols use block-oriented and file-oriented storage models that incur greater latency and require more complex handling than the simpler, hardware-based remote direct memory access model.

### SUMMARY

A data retention system having a plurality of access protocols is described in the present disclosure. In one embodiment, the system comprises a memory store accessible through a virtual address space, a controller communicatively coupled to the memory store, and an interface. The controller is adapted to implement a memory access protocol for accessing at least a first portion of the virtual address space and a secondary storage protocol for accessing at least a second portion of the virtual address space. The interface is communicatively coupled to the controller, and is able to be communicatively coupled to a communications link.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating components of a storage appliance linked to client processors.

FIG. 2 is a data flow diagram illustrating further detail of the storage appliance.

FIG. 3 is a diagram illustrating an exemplary virtual address space.

FIG. 4 is a diagram illustrating exemplary mass storage protocols and memory access protocols that may be implemented using a storage appliance.

FIG. 5 depicts exemplary storage appliance functionality that is accessible using a management interface according to an embodiment of the invention.

### DETAILED DESCRIPTION

Due in part to the widespread use of computer systems designed to communicate with traditional storage systems using traditional mechanisms and protocols, such as SCSI, and which cannot be made to use newer technologies and protocols without considerable expense or delay, it is desirable that new storage systems offer multiple kinds of communication mechanisms and protocols to an associated CPU. This is particularly true when the storage system is implemented with typical high performance solid state memory devices.

The present disclosure therefore describes a digital information retention appliance, intended for connection to one or more CPUs through one or more data communication networks, whose salient features include a capability to communicate using more than one access protocol. In some embodiments, the appliance includes a capability to simultaneously communicate with several CPUs which are not all necessarily using the same access protocol. In an extension of this multi-protocol capability, one or more partitions of the data retained in the appliance can be freely presented to any combination of CPUs, using any combination of the available protocols provided by the appliance, at either the same time or different times.

Reference will now be made in detail to an embodiment of the present invention, an example of which is illustrated in the accompanying drawings, wherein like reference numerals illustrate corresponding or similar elements throughout the several views.

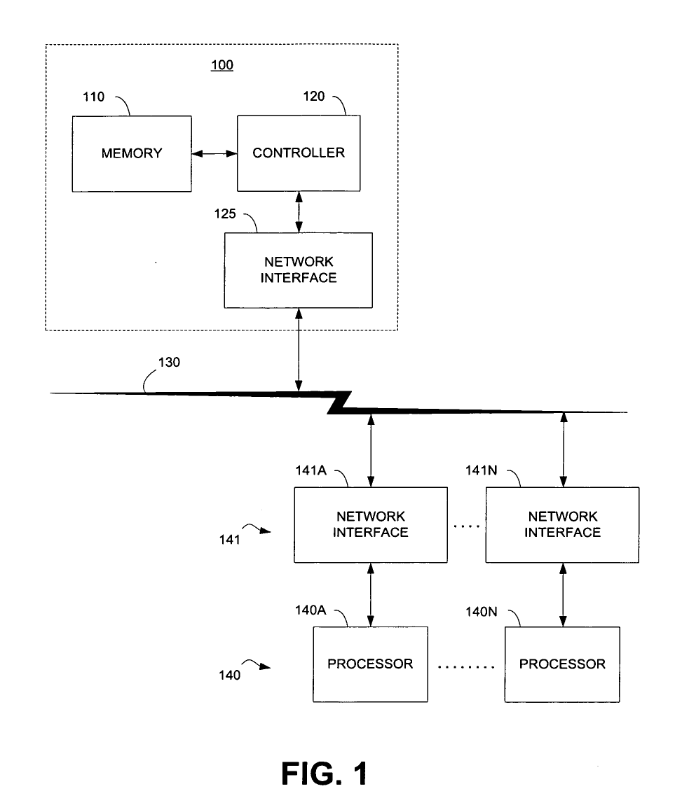

FIG. 1 depicts a storage appliance 100 that includes a memory store 110 communicatively coupled to a controller 120. The controller 120 is communicatively coupled to a network interface 125. The network interface 125 is able to be communicatively coupled to a communications link 130. One or more client processors 140A . . . 140N (collectively client processors 140) may be communicatively coupled to the communications link 130, such as through respective network interfaces 141A . . . 141N (collectively network interfaces 141).

The memory store 110 can contain memory that is protected against loss of power for an extended period of time. In some implementations, the memory store 110 may be able to store data regardless of the amount of time power is lost; in other implementations, the memory store 110 may be able to store data for only a few minutes or hours.

The memory store 110 is persistent like traditional I/O storage devices, but is able to be accessed somewhat like system memory, with fine granularity and low latency, but using a remote direct memory access protocol. In addition, the storage appliance 100 offers access to the memory store 110 using a mass storage protocol, to permit the use of block-oriented and file-oriented I/O architectures, notwithstanding their relatively large latencies.

In a preferred embodiment, the storage appliance 100 comprises a persistent memory (PM) unit. The persistent memory unit may comprise the memory store 110. In some embodiments, the persistent memory unit may comprise the combination of the memory store 110 and the controller 120. One example of a persistent memory unit is described by Mehra et al. in U.S. Pub. No. 2004/0148360 A1 (Attorney Docket No. 200209691-1), which is commonly assigned with the present application, and which discloses a structural architecture for communication-link-attached persistent memory. Persistent memory has relevant characteristics generally lying intermediate between the extremes of direct memory access and mass storage protocols. In summary, persistent memory is intended to provide durable retention of data and self-consistent metadata while maintaining the access semantics, byte-level granularity and alignment, and retention of data structures (such as pointers) associated with memory accesses. A well-defined access architecture and application programming interface (API) may be provided for embodiments of persistent memory units.

A salient feature of the storage appliance 100 is that access to the memory store 110 is generally faster than access to traditional mass storage systems (such as those incorporating rotating magnetic disks), and preferably as close as possible to the high speeds of local main memory systems, subject to considerations of cost and the state of the art. Conversely, the information retention capacity of the storage appliance 100 is generally larger than that of a traditional main memory system (such as dynamic RAM connected to a motherboard or local bus), and preferably as close as possible to the high capacities of traditional mass storage systems, subject to considerations of cost and the state of the art. Examples of traditional mass storage systems include disk drives, tape drives, and optical drives.

The controller 120 is adapted to provide access to the memory contained in memory store 110 over the communications link 130, through the network interface 125. The controller 120 may in some embodiments include one or more processors, together with software and/or firmware (which may, for example, reside on the controller 120 or on a medium readable by the controller 120), for performing control functions such as implementing access protocols, performing management functions, and the like. Although only a single controller 120 is illustrated, it will be understood by those skilled in the art that a dual or multiple controller 120 architecture may also be implemented, for example to improve data availability. In an embodiment of the invention, the controller 120 is responsive to multiple access protocols, including at least one mass storage protocol and at least one memory access protocol, and is able to assign a selected access protocol to a memory address range of the memory store 110. When the controller 120 receives a storage access command (such as a command to read, write, load, store, or the like), the controller 120 executes the storage access command according to the selected access protocol.

The network interface 125 may, for example, include a network interface card, board, or chip set. The network interface 125 may in some embodiments include one or more hardware connectors (such as ports, jacks, and the like) for coupling the network interface 125 to the communications link 130. In other embodiments, the network interface 125 may be able to wirelessly communicate with the communications link 130.

In some embodiments, the storage appliance 100 may also include a case or enclosure (not shown) for containing the memory store 110, controller 120, and network interface 125, such that the storage appliance 100 is a physically distinct unit, with one or more access points provided for communicatively coupling the network interface 125 to the communications link 130.

Examples of the communications link 130 include a storage area network (SAN), the Internet, and other types of networks. The communications link 130 may in some embodiments include a plurality of networks. In some embodiments, the communications link 130 may itself provide basic memory management and virtual memory support. In one implementation, the communications link 130 is an RDMA-enabled SAN, commercially available examples of which include Fibre Channel-Virtual Interface (FC-VI), ServerNet, GigaNet cLAN or VI-over-IP, InfiniBand, PCI Express, RDMA-enabled Ethernet, and Virtual Interface Architecture (VIA) compliant SANs.

Further examples of the communications link 130 include links having characteristics of both a bus and a network, such as Fibre Channel, other high speed storage buses, and the like. Exemplary characteristics of buses include shared communication links between subsystems (such as CPU-memory buses and I/O buses), which generally allow split transactions and include bus mastering protocols for arbitration. Exemplary characteristics of networks include a switched topology of point to point links, more aggregate bandwidth than a typical bus, and the ability to span greater physical distances than a typical bus.

The communications link 130 facilitates communication between or among a plurality of devices connected through interfaces such as network interface 141A. Network interface 141A is able to be communicatively coupled to the communications link 130. A client processor 140A is communicatively coupled to the network interface 141A. In some embodiments, a plurality of client processors 140 may be communicatively coupled to a single network interface 141A that includes a router or other system for communicatively coupling multiple client processors 140 to the communications link 130. In some implementations, the communications link 130 is a network (such as a storage area network or a system area network), the client processors 140 (each of which may contain one or more CPUs) are nodes on the network, and the network interfaces 141 are network interface cards (NICs), controllers, boards, or chip sets.

Because the storage appliance 100 has an independent connection through network interface 125 to the communications link 130, the storage appliance 100 can operate independently of any particular one of the client processors 140. In an illustrative example, even if one particular client processor 140A fails, the data stored in memory store 110 (whether stored using a mass storage protocol or a memory access protocol) will be accessible to surviving client processors 140 on communications link 130. An alternate one of the client processors 140, such as a spare, will rapidly be able to access stateful information stored via persistent memory protocols and to assume the processing role of the failed client processor 140A.

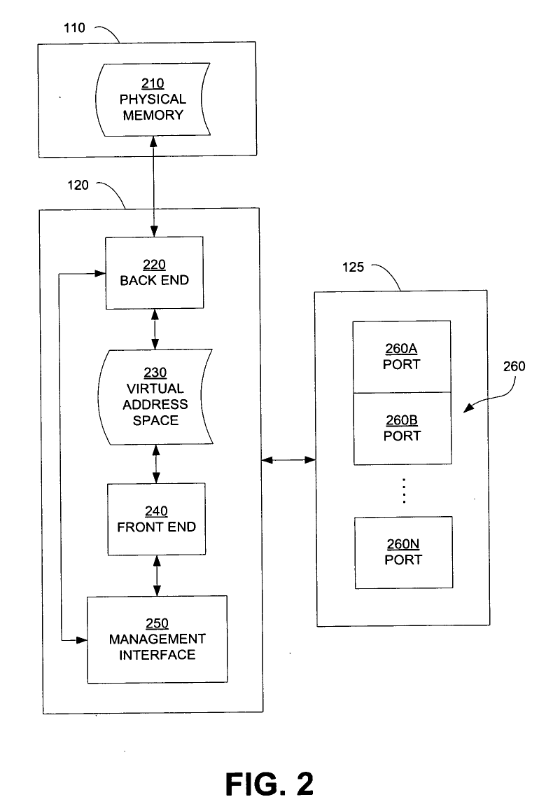

FIG. 2 is a data flow diagram illustrating further detail of a storage appliance according to an embodiment of the invention. The memory store 110 comprises physical memory 210. Physical memory 210 may, for example, include non-volatile random access memory, or volatile random access memory protected by a backup power source such as a battery. Examples of appropriate memory technologies for physical memory 210 include, but are not limited to, magnetic random access memory (MRAM), magneto-resistive random access memory (MRRAM), polymer ferroelectric random access memory (PFRAM), ovonics unified memory (OUM), battery-backed dynamic random access memory (BBDRAM), Flash memories of all kinds, or other non-volatile memory (NVRAM) technologies such as FeRAM or NROM. The memory store 110 may include one or more such memory technologies, which may be implemented using physical memory 210 in any of numerous configurations which will be apparent to one skilled in the art. Such hardware configurations of the physical memory 210 may include, for example, arrangements of one or more semiconductor chips on one or more printed circuit boards. The memory store 110 may, in some embodiments, include a power source such as a battery backup power supply (not shown) for the physical memory 210. In other embodiments, the storage appliance 100 may include technology for backing up physical memory 210 to a non-volatile mass storage system such as a hard drive or array of drives.

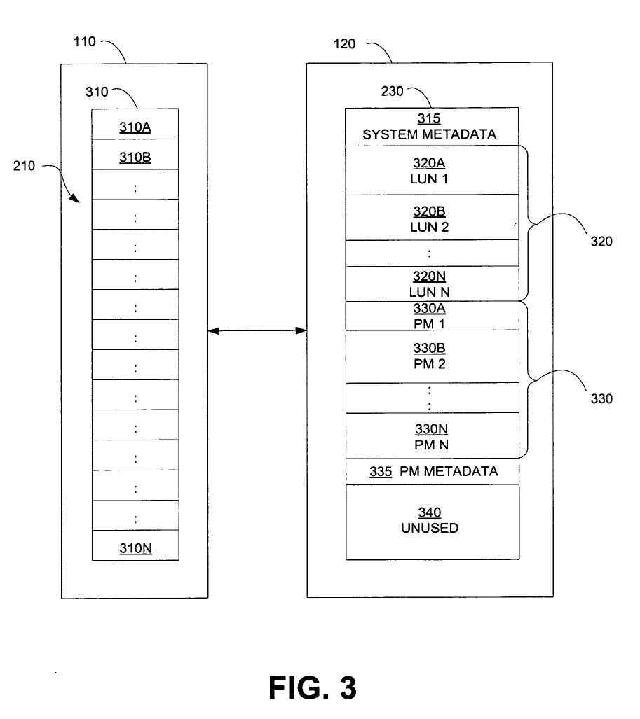

The controller 120 is adapted to implement back-end functionality 220 for using and controlling the physical memory 210. The physical memory 210 may be physically and/or logically mapped to at least one address range for accessing the memory resources therein. For example, the back-end functionality 220 is able to map the physical memory 210 to a virtual address space 230 (discussed in greater detail with respect to FIG. 3 below).

The back-end functionality 220 of the controller 120 includes, in some embodiments, health monitoring features such as an ability to detect failure of a memory component of the physical memory 210, or failure of hardware such as a connector of the network interface 125. In further embodiments, back-end functionality 220 includes features for maintaining data integrity in the physical memory 210. Illustrative examples of such features include functionality for error correction code (ECC), striping, redundancy, mirroring, defect management, error scrubbing, and/or data rebuilding. In still further embodiments, back-end functionality 220 includes layout functions relating to the physical memory 210.

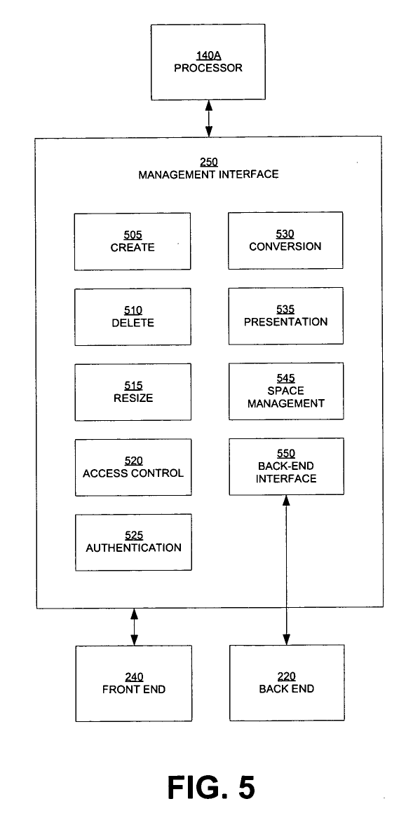

The controller 120 also is adapted to implement front-end functionality 240 for using and controlling resources including the virtual address space 230. For example, the front-end functionality 240 includes functionality for creating single or multiple independent, indirectly-addressed memory regions in the virtual address space 230. In some embodiments, the front-end functionality 240 of the controller 120 includes access control, for example, to restrict or allow shared or private access by one or more client processors 140 to regions of the memory store 110, such as in a manner similar to the functionality in a conventional disk-array storage controller. Additional functions and features of the front-end functionality 240 are discussed below with respect to FIG. 5.

A management interface 250, such as an API or a specialized software application, is provided for accessing front-end functionality 240 of the controller 120. In some embodiments, the management interface 250 is also able to access back-end functionality 220.

A network interface 125 is provided to allow the controller 120 to communicate over the communications link 130. In some embodiments, the network interface 125 includes one or more hardware connectors such as ports 260, for coupling the network interface 125 to the communications link 130. In an illustrative example, ports 260 may include a Fibre Channel (FC) port 260A for implementation of a mass storage protocol, an InfiniBand (IB) port 260B for implementation of a memory access protocol, an Ethernet port 260N for implementation of a mass storage protocol (such as iSCSI) and/or a memory access protocol (such as RDMAP) as may be desired, and the like.

FIG. 3 illustrates an exemplary virtual address space 230 according to an embodiment of the invention. The illustration depicts an example of how partitions or regions of memory may be allocated in the virtual address space 230.

Solid-state storage and other memory technologies suitable for memory store 110 will probably continue to be a more expensive medium for the durable, non-volatile retention of data than rotating magnetic disk storage. Hence, a computer facility such as a data center may choose to dynamically allocate the relatively expensive physical memory 210 included in the memory store 110 between multiple software applications and/or multiple client processors 140. The storage appliance 100 preferably allows the flexibility to allocate physical memory 210 resources of the memory store 110 to meet the needs of client processors 140 and software applications running thereon, as desired to maximize the utility of this expensive resource.

Physical memory 210 may be divided into physical memory address ranges 310A, 310B, . . . , 310N (collectively physical memory address space 310). Granularity may in some implementations be made finer or coarser as desired, to accommodate byte-level or block-level operations on physical memory address space 310. In an illustrative example showing byte-level granularity, physical memory address range 310A begins at an offset of zero bytes from a known starting address, physical memory address range 310B begins at an offset of one byte from the known starting address, and so forth. The physical memory address space 310 is generally consecutive; however, in some implementations, the physical memory address space 310 may include nonconsecutive or noncontiguous address ranges.

The controller 120 is able to support virtual-to-physical address translation for mapping the physical memory address space 310 to virtual address space 230. Memory management functionality is provided for creating single or multiple independent, indirectly-addressed memory ranges in the virtual address space 230. In the illustrated embodiment, exemplary memory ranges are shown. These exemplary memory ranges include system metadata 315, SCSI logical units 320A, 320B, . . . , 320N (collectively storage volumes 320), persistent memory regions 330A, 330B, . . . , 330N (collectively memory regions 330), persistent memory metadata 335, and an unused region 340.

A memory range (i.e., any contiguous region or portion of virtual address space 230, such as any one of storage volumes 320 or any one of memory regions 330), can be mapped or translated by the controller 120 to one or more address ranges within the physical memory address space 310. The contiguous memory range in the virtual address space 230 may correspond to contiguous or discontiguous physical address ranges in the physical memory address space 310. The memory range of virtual address space 230 may be referenced relative to a base address of the memory range (or in some implementations, a base address of the virtual address space 230) through an incremental address or offset. In some embodiments, such memory ranges may be implemented using one or more address contexts (i.e., address spaces that are contextually distinct from one another), such as those supported by conventional VIA-compatible networks.

The controller 120 must be able to provide the appropriate translation from the virtual address space 230 to the physical memory address space 310 and vice versa. In this way, the translation mechanism allows the controller 120 to present contiguous virtual address ranges of the virtual address space 230 to client processors 140, while still allowing dynamic management of the physical memory 210. This is particularly important because of the persistent or non-volatile nature of the data in the memory store 110. In the event of dynamic configuration changes, the number of processes accessing a particular controller 120, or possibly the sizes of their respective allocations, may change over time. The address translation mechanism allows the controller 120 to readily accommodate such changes without loss of data. The address translation mechanism of the controller 120 further allows easy and efficient use of capacity of memory store 110 by neither forcing the client processors 140 to anticipate future memory needs in advance of allocation nor forcing the client processors 140 to waste capacity of memory store 110 through pessimistic allocation.

One or more memory ranges in virtual address space 230 may be partitioned among client processors 140 connected to the communications link 130. Each memory range or each such partition may be assigned a mass storage protocol or a memory access protocol. In this manner, the one or more client processors 140 can access one or multiple memory ranges of the virtual address space 230, either as a storage volume 320 accessed through a mass storage protocol, or as a memory region 330 accessed through a memory access protocol. Any one of the storage volumes 320 (such as LUN 1 320A, LUN 2 320B, and so forth) may, for example, be accessed using a SCSI logical unit number (LUN) to associate the memory range of the storage volume 320 with a virtual device. The storage volumes 320 are virtual storage volumes; i.e., any one of the storage volumes 320 is similar to a RAM disk in that it is implemented in memory and may be accessed using mass storage protocols for transferring blocks of data. In other embodiments, the storage volumes 320 need not be implemented as SCSI logical units, but may use other storage paradigms. In some embodiments, a memory range in the virtual address space 230 may be accessed using a plurality of available access protocols, rather than being limited to a single access protocol assigned to each region.

System metadata 315 may contain information describing the contents, organization, layout, partitions, region types, sizes, access control data, and other information concerning the memory ranges within virtual address space 230 and/or memory store 110. In this way, the storage appliance 100 stores data and the manner of using the data. System metadata 315 may be useful for purposes such as memory recovery, e.g., after loss of power or processor failure. When the need arises, the storage appliance 100 can then allow for recovery from a power or system failure.

Similarly, in embodiments that include persistent memory (PM), the PM metadata 335 may contain information (independent from or overlapping the information of system metadata 315) describing the contents, organization, layout, partitions, region types, sizes, access control data, and other information concerning the memory ranges within memory regions 330. In this embodiment, management of memory regions 330 and PM metadata 335 is carried out by persistent memory management (PMM) functionality that can be included in the front-end functionality 240 and/or in the management interface 250, and may reside on the controller 120 or outside the controller 120 such as on one of the client processors 140. Because the memory store 110 is durable or non-volatile (like a disk), and because the storage appliance 100 maintains a self-describing body of persistent data, the PM metadata 335 related to existing persistent memory regions 330 must be stored on the storage appliance 100 itself. The PMM therefore performs management tasks in a manner that will always keep the PM metadata 335 consistent with the persistent data stored in persistent memory regions 330, so that the stored data of memory regions 330 can always be interpreted using the stored PM metadata 335 and thereby recovered after a possible system shutdown or failure. In this way, a storage appliance 100 maintains in a persistent manner not only the data being manipulated but also the state of the processing of such data. Upon a need for recovery, the storage appliance 100 using persistent memory regions 330 and PM metadata 335 is thus able to recover and continue operation from the memory state in which a power failure or operating system crash occurred.

In situations where a persistent memory region 330 contains pointers or structured content, such as data structures or an in-memory database, the PM metadata 335 may contain information defining or describing applicable data structures, data types, sizes, layouts, schemas, and other attributes. In such situations, the PM metadata 335 may be used by the appliance 100 to assist in translation or presentation of data to accessing clients.

In yet other situations, the PM metadata 335 may contain application-specific metadata exemplified by, but not limited to, information defining or describing filesystem data structures, such as i-nodes (internal nodes) for a filesystem defined within one or more PM regions 330. In these situations the PMM functionality of the controller 120 is not necessarily required to be involved in managing such application-specific metadata. Responsibility for such application-specific metadata may instead reside in application software running on a client processor 140, or in a device access layer running on a client processor 140.

In some embodiments (for example, a ServerNet RDMA-enabled SAN), the communications link 130 itself provides basic memory management and virtual memory support, as noted above in the description of FIG. 1. Such functionality of the communications link 130 may be suitable for managing virtual address space 230. In such an implementation, the management interface 250 or controller 120 must be able to program the logic in the network interface 125 in order to enable remote read and write operations, while simultaneously protecting the memory store 110 and virtual address space 230 from unauthorized or inadvertent accesses by all except a select set of entities on the communications link 130.

Unused space 340 represents virtual address space 230 that has not been allocated to any of the storage volumes 320, memory regions 330, or metadata 315, 335. Unused space 340 may in some embodiments be maintained as a memory region or unallocated portion of the virtual address space 230. In other embodiments, the virtual address space 230 may simply be smaller than the physical memory address space 310, so that unused portions of the physical memory address space 310 have no corresponding memory ranges in the virtual address space 230.

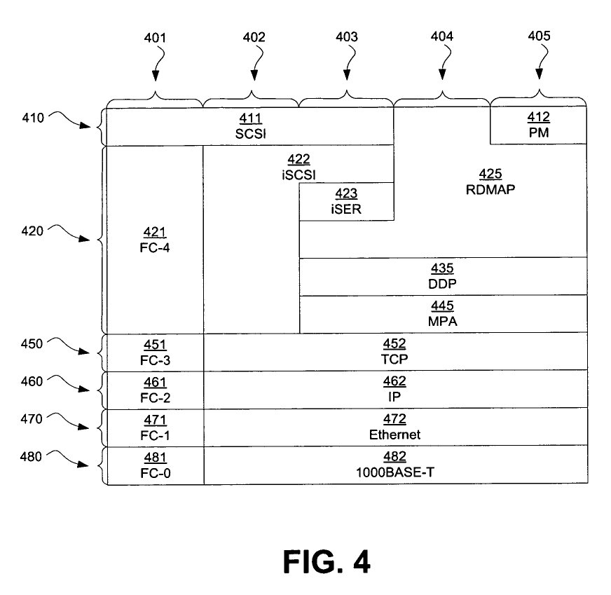

FIG. 4 depicts exemplary mass storage protocols and memory access protocols that may be implemented using a storage appliance 100 according to an embodiment of the invention. Exemplary mass storage protocols include SCSI 411. Exemplary memory access protocols include RDMA protocol 425 and a persistent memory protocol 412.

A storage appliance 100 may use protocol stacks, such as exemplary protocol stacks 401-405, to provide access to the memory store 110 compatibly with one or more mass storage protocols and one or more memory access protocols. A protocol stack 401-405 is a layered set of protocols able to operate together to provide a set of functions for communicating data over a network such as communications link 130.

A protocol stack 401-405 for the storage appliance 100 may be implemented by the controller 120 and/or the network interface 125. For example, upper level protocol layers may be implemented by the controller 120 and lower level protocol layers may be implemented by the network interface 125. Corresponding protocol layers on the other side of communications link 130 may be implemented by client processors 140 and/or network interfaces 141.

The exemplary protocol stacks 401-405 include an upper level protocol layer 410. The upper level protocol layer 410 is able to provide a high level interface accessible to an external software application or operating system, or, in some implementations, to a higher layer such as an application layer (not shown). One or more intermediate protocol layers 420 may be provided above a transport layer 450 having functions such as providing reliable delivery of data. A network layer 460 is provided for routing, framing, and/or switching. A data link layer 470 is provided for functions such as flow control, network topology, physical addressing, and encoding data to bits. Finally, a physical layer 480 is provided for the lowest level of hardware and/or signaling functions, such as sending and receiving bits.

Protocol stacks 401-403 are three illustrative examples of protocol stacks for mass storage protocols. Mass storage protocols typically transfer data in blocks, and representative system calls or APIs for a mass storage protocol include reads and writes targeted to a specified storage volume (such as a LUN) and offset.

In one implementation, protocol stack 401 is a mass storage protocol for accessing at least a portion of the virtual address space 230 (such as one of the storage volumes 320) as disk-type storage, via Fibre Channel (FC). The upper level protocol 410 in the exemplary implementation is SCSI 411. Conventional implementations of Fibre Channel provide protocol layers known as FC-4, FC-3, FC-2, FC-1, and FC-0. An FC-4 layer 421 (SCSI to Fibre Channel) is provided as an intermediate protocol layer 420. An FC-3 layer 451 is provided as a transport layer 450. An FC-2 layer 461 is provided as a network layer 460. An FC-1 layer 471 is provided as a data link layer 470. Finally, an FC-0 layer 481 is provided as a physical layer 480.

In another implementation, protocol stack 402 is a mass storage protocol for accessing at least a portion of the virtual address space 230 (such as one of the storage volumes 320) as disk-type storage, via iSCSI. iSCSI is a protocol developed for implementing SCSI over TCP/IP. The upper level protocol 410 in the implementation is SCSI 411. An iSCSI layer 422 is provided as an intermediate protocol layer 420. A Transmission Control Protocol (TCP) layer 452 is provided as a transport layer 450. An Internet Protocol (IP) layer 462 is provided as a network layer 460. An Ethernet layer 472 is provided as a data link layer 470. Finally, a 1000BASE-T layer 482 is provided as a physical layer 480.

In still another implementation, protocol stack 403 is a mass storage protocol for accessing at least a portion of the virtual address space 230 (such as one of the storage volumes 320) as disk-type storage, via iSCSI with iSER. iSER (an abbreviation for “iSCSI Extensions for RDMA”) is a set of extensions to iSCSI, developed for implementing an iSCSI layer 422 over an RDMA protocol. The upper level protocol 410 in the implementation is SCSI 411. Intermediate protocol layers 420 are an iSCSI layer 422, over an iSER layer 423, over an RDMAP layer 425, over a DDP layer 435, over an MPA layer 445. DDP layer 435 is a direct data placement protocol, and MPA layer 445 is a protocol for marker PDU (Protocol Data Unit) aligned framing for TCP. The RDMAP layer 425, DDP layer 435, and MPA layer 445 may be components of an iWARP protocol suite. A TCP layer 452 is provided as a transport layer 450, and an IP layer 462 is provided as a network layer 460. An Ethernet layer 472 is provided as a data link layer 470, and a 1000BASE-T layer 482 is provided as a physical layer 480.

Protocol stacks 404-405 are two illustrative examples of protocol stacks for memory access protocols. Memory access protocols typically transfer data in units of bytes. Representative system calls or APIs for an RDMA-based memory access protocol include RDMA read, RDMA write, and send. Representative system calls or APIs for a PM-based memory access protocol include create region, open, close, read, and write.

In one implementation, protocol stack 404 is a memory access protocol for accessing at least a portion of the virtual address space 230 (such as one of the memory regions 330) as memory-type storage, via RDMA. The upper level protocol 410 in the implementation is an RDMAP layer 425. Intermediate protocol layers 420 are a DDP layer 435, and an MPA layer 445. The RDMAP layer 425, DDP layer 435, and MPA layer 445 may be components of an iWARP protocol suite. A TCP layer 452 is provided as a transport layer 450, and an IP layer 462 is provided as a network layer 460. An Ethernet layer 472 is provided as a data link layer 470, and a 1000BASE-T layer 482 is provided as a physical layer 480.

In another implementation, protocol stack 405 is a memory access protocol for accessing at least a portion of the virtual address space 230 (such as one of the memory regions 330) as memory-type storage, via Persistent Memory over RDMA. The upper level protocol 410 in the implementation is a PM layer 412. Intermediate protocol layers 420 are an RDMAP layer 425, a DDP layer 435, and an MPA layer 445. The RDMAP layer 425, DDP layer 435, and MPA layer 445 may be components of an iWARP protocol suite. A TCP layer 452 is provided as a transport layer 450, and an IP layer 462 is provided as a network layer 460. An Ethernet layer 472 is provided as a data link layer 470, and a 1000BASE-T layer 482 is provided as a physical layer 480.

Embodiments of the storage appliance 100 may implement or be compatible with implementations of any of numerous other examples of protocol stacks, as will be apparent to one skilled in the art. It should be particularly noted that TCP/IP may readily be implemented over numerous alternate varieties and combinations of a data link layer 470 and physical layer 480, and is not limited to implementations using Ethernet and/or 1000BASE-T. Substitutions may be implemented for any of the exemplary layers or combinations of layers of the protocol stacks, without departing from the spirit of the invention. Alternate implementations may, for example, include protocol stacks that are optimized by replacing the TCP layer 452 with zero-copy, operating system bypass protocols such as VIA, or by offloading any software-implemented portion of a protocol stack to a hardware implementation, without departing from the spirit of the invention.

FIG. 5 depicts exemplary functionality of the storage appliance 100 that is accessible using the management interface 250. Client processor 140A is illustrated as an exemplary one of the client processors 140. Client processor 140A is able to communicate with the management interface 250, such as through the communications link 130 and network interfaces 125, 141A on either side of the communications link 130. The management interface 250 is able to communicate with front-end functionality 240 of the controller 120, and in some embodiments with back-end functionality 220 of the controller 120.

When a particular client processor 140A needs to perform functions relating to access to a memory range of the virtual address space 230, such as allocating or de-allocating memory ranges of the storage appliance 100, the processor 140A first communicates with the management interface 250 to call desired management functions.

In some embodiments, the management interface 250 may be implemented by the controller 120, as shown in FIG. 2. In other embodiments, the management interface 250 may be separately implemented outside the storage appliance 100, such as on one or more of the client processors 140, or may include features that are implemented by the controller 120 and features that are implemented by one or more client processors 140.

Because client processors 140 access the front-end functionality 240 through the management interface 250, it is not material whether a specific feature or function is implemented as part of the management interface 250 itself, or as part of the front-end functionality 240 of the controller. Accordingly, where the present application discusses features of the management interface 250 or of the front-end functionality 240, the invention does not confine the implementation of such features strictly to one or the other of the management interface 250 and the front-end functionality 240. Rather, such features may in some implementations be wholly or partially implemented in or performed by both or either of the front-end functionality 240 of the controller and/or the management interface 250.

The management interface 250 provides functionality to create 505 single or multiple independent, indirectly-addressed memory ranges in the virtual address space 230, as described above with reference to FIG. 2 and FIG. 3. A memory range of the virtual address space 230 may be created 505 as either a disk-type region (such as a storage volume 320) for use with mass storage protocols, or as a memory-type region (such as a memory region 330) for use with memory access protocols. A memory range of the virtual address space 230 generally may be accessed using only the type of access protocol with which it was created; that is, a storage volume 320 may not be accessed using a memory access protocol, and a memory region 330 may not be accessed using a mass storage protocol. Embodiments of the create 505 functionality may also include functions for opening or allocating memory ranges.

The management interface 250 also provides functionality to delete 510 any one of the storage volumes 320 or memory regions 330 that had previously been created 505 using the management interface 250. Embodiments of the delete 510 functionality may also include functions for closing or deallocating memory ranges.

In some embodiments, the management interface 250 may permit a resize 515 operation on an existing one of the storage volumes 320 or memory regions 330. An exemplary resize 515 function accepts parameters indicating a desired size. For example, the desired size may be expressed in bytes, kilobytes, or other data units. A desired size may also be expressed as a desired increment or decrement to the existing size. For example, if it is desired to enlarge an existing storage volume 320 or memory region 330, the management interface 250 may cause additional resources to be allocated from the physical memory address space 310.

Access control 520 capability may be provided by the management interface 250. The access control 520 may be able, for example, to manage or control the access rights of a particular client processor 140A to particular data retained in the virtual address space 230. For example, in some embodiments, the ability to delete 510 a particular one of the storage volumes 320 or memory regions 330 may be limited to the same client processor 140 that previously created 505 the desired subject of the delete 510 operation. The access control 520 may also be able to manage or control the amount, range, or fraction of the information storage capacity of the virtual address space 230 that is made available to a particular client processor 140A. Access control 520 may also include the capability for a client processor 140 to register or un-register for access to a given storage volume 320 or memory region 330.

Authentication 525 functionality may also be provided for authenticating a host, such as a client processor 140. In some embodiments, the management interface 250 may provide access control 520 and authentication 525 functionality by using existing access control and authentication capabilities of the communications link 130 or network interface 125.

In some embodiments of the invention, a conversion 530 capability may be provided, either to convert an entire memory range from one access protocol to another (conversion 530 of a memory range), or to convert at least a portion of the data residing in the memory range for use with an access protocol other than that of the memory range in which the data resides (conversion 530 of data), or both.

In implementations of conversion 530 of a memory range, a conversion 530 capability is provided to convert a storage volume 320 to a memory region 330, or vice versa. In some embodiments, data residing in an existing memory range may be copied from the existing memory range to a newly allocated storage volume 320 or memory region 330 (as appropriate). In other embodiments, attributes of the existing memory range are modified so as to eliminate the need for copying or allocating a new memory range to replace the converted memory range. Some implementations of conversion 530 of a memory range may include conversion 530 of data residing in the memory range.

In some embodiments, conversion 530 of data may take place without the conversion 530 of an entire memory range. For conversion 530 of data, some implementations of the management interface 250 may provide the ability to modify data structures stored with a memory access protocol (such as a persistent memory protocol), in order to convert 530 the data structures into storage files, blocks, or objects consistent with a desired mass storage protocol. Conversely, the management interface 250 may allow conversion of data stored using mass storage protocols, such as a database file in a storage volume 320, to a memory region 330 using memory access protocols (such as persistent memory semantics). Specific instructions and information for conversion 530 of such data structures may generally be provided by a software application or operating system that accesses the applicable region of virtual address space 230, as well as by associated system metadata 315, and any PM metadata 335 associated with or describing the memory region 330. In an illustrative example, the management interface 250 may provide functionality for easy conversion 530 of an in-memory database using pointers in a memory region 330 (such as a linked list or the like) to a set of database records in a storage volume 320, or vice versa. In this manner, the storage appliance 100 performs storage protocol offload functionality for the client processors 140.

In further embodiments of the conversion 530 function, all client processors 140 registered to access a particular memory range of the virtual address space 230 under a first type of protocol may be required by the management interface 250 to un-register from that memory range, before the management interface 250 will permit the same or other client processors 140 to re-register to access the memory range under another type of protocol.

Presentation 535 functionality may be provided in some embodiments of the management interface 250, to permit selection and control of which hosts (such as client processors 140) may share storage volumes 320 and/or memory regions 330. For example, the ability may be provided to restrict or mask access to a given storage volume 320 or memory region 330. The storage volumes 320 and/or memory regions 330 are presented as available to the selected hosts, and are not presented to unselected hosts. Presentation 535 functionality may also include the ability to aggregate or split storage volumes 320 or memory regions 330. In some embodiments, presentation 535 functionality may enable the virtual aggregation of resources from multiple storage volumes 320 and/or memory regions 330 into what appears (to a selected client processor 140) to be a single storage volume 320 or memory region 330.

Space management 540 functionality may be provided in some embodiments of the management interface 250, for providing management and/or reporting tools for the storage resources of the storage appliance 100. For example, space management 540 functionality may include the ability to compile or provide information concerning storage capacities and unused space in the storage appliance 100 or in specific storage volumes 320 or memory regions 330. Space management 540 functionality may also include the ability to migrate inactive or less-recently used data to other storage systems, such as a conventional disk-based SAN, thereby releasing space in the storage appliance 100 for more important active data.

In some embodiments, the management interface 250 may include a back-end interface 550, for providing access to back end functionality 220 of the controller 120, thereby allowing the client processor 140 to access or monitor low-level functions of the storage appliance 100.

It will be apparent to those skilled in the art that further modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system for data retention with a plurality of access protocols, comprising
a memory store accessible through a virtual address space,
a controller communicatively coupled to the memory store, said controller being adapted to implement a memory access protocol for accessing at least a first portion of the virtual address space and a secondary storage protocol for accessing at least a second portion of the virtual address space, and
an interface communicatively coupled to the controller, and able to be communicatively coupled to a communications link.

2. The system of claim 1 wherein the memory store comprises solid-state electronic memory.

3. The system of claim 1 wherein the memory store comprises non-volatile memory.

4. The system of claim 1 wherein the memory store comprises solid-state electronic memory and non-volatile memory.

5. The system of claim 1 wherein the memory store comprises volatile memory operatively coupled to a backup power source.

6. The system of claim 1 wherein a persistent memory unit comprises the memory store.

7. The system of claim 6 wherein a persistent memory unit contains the controller.

8. The system of claim 1 wherein the memory access protocol comprises a persistent memory access protocol.

9. The system of claim 1 wherein the memory access protocol comprises a remote direct memory access protocol.

10. The system of claim 1 wherein the secondary storage protocol is suitable for accessing a mass storage system.

11. The system of claim 1 wherein the secondary storage protocol comprises a SCSI protocol.

12. The system of claim 1 wherein a region of the virtual address space is accessible as one or more storage volumes.

13. The system of claim 1 wherein a region of the virtual address space is accessible as one or more SCSI logical units.

14. The system of claim 1 wherein a region of the virtual address space is accessible as one or more persistent memory regions.

15. The system of claim 1 wherein a region of the virtual address space comprises metadata for describing at least a second region of the virtual address space.

16. The system of claim 1 wherein the communications link comprises a network.

17. The system of claim 1 wherein one or more client processors are communicatively coupled to the communications link.

18. The system of claim 1 wherein the controller is adapted to implement concurrently the memory access protocol and the secondary storage protocol for accessing a selected region of the virtual address space.

19. The system of claim 1 wherein a region of the virtual address space comprises metadata for describing at least a selected region of the virtual address space, and the controller is adapted to convert an accessibility of the selected region from a first access protocol to a second access protocol, using the metadata.

20. The system of claim 1 wherein a client processor is communicatively coupled to the communications link,
a region of the virtual address space comprises metadata for describing at least a selected region of the virtual address space, and
the client processor is adapted to convert an accessibility of the selected region from a first access protocol to a second access protocol, using the metadata.

21. The system of claim 1 wherein the controller is adapted to manage the memory store responsively to a management interface.

22. The system of claim 1 wherein the controller is adapted to manage the virtual address space responsively to a management interface.

23. A storage device comprising:
a non-volatile memory communicatively coupled to a controller, and
at least one interface communicatively coupled to the controller for connecting the controller to a network,
the controller being able to provide at least a memory access protocol for accessing data in the non-volatile memory over the network and a mass storage protocol for accessing data in the non-volatile memory over the network.

24. The device of claim 23 wherein the non-volatile memory comprises random access memory coupled to a backup power source.

25. The device of claim 23 wherein the non-volatile memory comprises persistent memory.

26. The device of claim 23 wherein the memory access protocol comprises a persistent memory access protocol.

27. The device of claim 23 wherein the memory access protocol comprises a remote direct memory access protocol.

28. The device of claim 23 wherein the mass storage protocol is suitable for accessing a mass storage system.

29. The device of claim 23 wherein the mass storage protocol comprises a SCSI protocol.

30. A method for accessing a network-connected storage unit, comprising:
providing a controller responsive to a plurality of access protocols comprising at least a memory protocol and a storage protocol,
assigning a selected access protocol to a memory address range of the storage unit,
receiving a command at a management interface for the controller, and
executing the command compatibly with the selected access protocol.

31. The method of claim 30 wherein the memory address range is a virtual memory address range.

32. The method of claim 30 wherein the command is one of the group consisting of a create command, a delete command, a resize command, an access control command, an authentication command, a conversion command, a presentation command, and a space management command.

33. The method of claim 30 wherein executing the command further comprises mapping at least a portion of a physical memory store to the memory address range for access according to the selected access protocol.

34. The method of claim 30 wherein executing the command further comprises deallocating the memory address range.

35. The method of claim 30 wherein executing the command further comprises allocating to the memory address range at least a portion of a physical memory store having a desired size.

36. The method of claim 30 wherein executing the command further comprises managing an access right of a requestor connected to the storage unit.

37. The method of claim 30 wherein executing the command further comprises authenticating a requestor connected to the storage unit.

38. The method of claim 30 wherein executing the command further comprises converting data of the memory address range from a first access protocol accessibility to a second access protocol accessibility.

39. The method of claim 38 further comprising providing metadata for describing at least a selected region of the memory address range,
wherein converting data further comprises using the metadata for modifying a structure of the data.

40. The method of claim 30, further comprising providing metadata for describing at least a portion of data residing in the memory address range,
wherein executing the command further comprises using the metadata to modify a structure of the at least a portion of data for accessibility according to a selected access protocol.

41. The method of claim 30 wherein executing the command further comprises presenting the memory address range to one or more selected processors.

42. The method of claim 30 wherein executing the command further comprises migrating a portion of the memory address range to a second storage unit.

43. The method of claim 30 wherein executing the command further comprises calling a back-end function of the controller.

44. The method of claim 30 wherein the memory protocol comprises a persistent memory access protocol.

45. The method of claim 30 wherein the memory protocol comprises a remote direct memory access protocol.

46. The method of claim 30 wherein the storage protocol comprises a mass storage protocol suitable for accessing a mass storage system.

47. The method of claim 30 wherein the storage protocol comprises a SCSI protocol.

48. A computer-readable medium containing a set of instructions for accessing a storage unit, the set of instructions comprising steps for:
responding to a plurality of access protocols comprising at least a memory protocol and a storage protocol,
assigning a selected access protocol to a memory address range of the storage unit,
receiving an storage access command, and
executing the storage access command according to the selected access protocol.

49. The medium of claim 48 wherein the memory protocol comprises a persistent memory access protocol.

50. The medium of claim 48 wherein the memory protocol comprises a remote direct memory access protocol.

51. The medium of claim 48 wherein the storage protocol comprises a mass storage protocol suitable for accessing a mass storage unit.

52. The medium of claim 48 wherein the storage protocol comprises a SCSI protocol.

53. The medium of claim 48 wherein executing the storage access command further comprises converting the memory address range from accessibility according to a non-selected access protocol to accessibility according to the selected access protocol.

54. The medium of claim 48, wherein the storage unit further comprises metadata for describing at least a portion of data residing in the memory address range,
and executing the storage access command further comprises using the metadata to modify a structure of the at least a portion of data for accessibility according to the selected access protocol.

55. A data storage appliance, comprising:
a data storage means for storing data,
a controller means for accessing at least a first portion of the data according to a memory access protocol, and for accessing at least a second portion of the data according to a mass storage protocol, and
an interface means for facilitating communications between the controller means and a communications link.
